(19) United States
(12) Patent Application Publication
(10) Pub. No.: US 2026/0006497 A1
(43) Pub. Date: Jan. 1, 2026

(54) DISCOVERY OF DEVICES IN A VIRTUAL EXPERIENCE SERVICE IN A WIRELESS COMMUNICATION NETWORK

(71) Applicant: Lenovo (Singapore) Pte. Ltd., Singapore (SG)

(72) Inventors: Emmanouil Pateromichelakis, Viersen (DE); Dimitrios Karampatsis, Ruislip (GB)

(21) Appl. No.: 18/881,180

(22) PCT Filed: Aug. 24, 2022
(86) PCT No.: PCT/EP2022/073568

§ 371 Date: Jan. 3, 2025

(30) Foreign Application Priority Data
Jul. 6, 2022 (GR) 20220100538

(51) Int. Cl. H04W 28/18; H04L 65/1063; H04L 67/60

(52) U.S. Cl. CPC H04W 28/18; H04L 65/1063; H04L 67/60

(57) ABSTRACT

There is provided a configuration entity in a wireless communication network, the configuration entity comprising a receiver, a processor and a transmitter. The receiver is arranged to receive a service requirement for communication of virtual devices within a virtual experience service at the wireless communication network, wherein each virtual device corresponds to a physical device identified by a subscriber identity. The processor is arranged to discover a plurality of candidate digital and physical devices for a given area and based on the received service requirement. The processor is further arranged to derive one or more session requirements from the received service requirement; wherein a session is established between any combination of the plurality of candidate digital and physical devices. The processor is further still arranged to determine a parameter for each session. The transmitter is arranged to transmit the determined parameter to at least one network node.

### FIELD

The subject matter disclosed herein relates generally to the field of implementing discovery of devices in a virtual experience service in a wireless communication network. This document defines a configuration entity in a wireless communication network and a method in a configuration entity.

### BACKGROUND

Virtual reality (VR), Augmented Reality (AR) and Extended Reality (XR) are types of virtual experience services whereby users of electronic devices can interact with each other. Such a virtual experience service can use cryptocurrency to conduct transactions. Such transactions may comprise the exchange of digital works including, but not limited to, non-fungible tokens (NFTs).

The metaverse is an example of such a virtual space that may be provided by a virtual experience service. The metaverse is an open, shared, and persistent virtual world that offers access to the 3D virtual spaces, solutions, and environments created by users. The metaverse is a digital reality that combines aspects of social media, online gaming, augmented reality (AR), virtual reality (VR), and cryptocurrencies to allow users to interact virtually. As the metaverse grows, it will create online spaces where user interactions are more multidimensional than current technology supports. Instead of just viewing digital content, users in the metaverse will be able to immerse themselves in a space where the digital and physical worlds converge.

In the metaverse, everything the user creates and owns in the metaverse is their asset, whether it is a piece of virtual real estate or an artifact. The metaverse confers the privileges of complete ownership on its users. Moreover, the persistency factor is very important since even if a user exits the metaverse, the digital avatar would still be in the metaverse. It would run normally with other users engaging and interacting with the metaverse. An avatar, a digital object, a virtual device, an object in the metaverse, and a digital twin are all different representations of the objects/devices instantiated/deployed in the virtual space of the virtual experience service. By some definitions, avatars are our digital representatives in the virtual space. For example, a metaverse avatar of a user is essentially a manifestation of the user and/or their user equipment within the metaverse. The avatar can look exactly like the user or device looks in the real world or can be augmented. As such, an avatar UE can be considered to be a digital representation of the user's device virtualized in the metaverse. The user's device may be a mobile phone, a cellular telephone, smart glasses, and/or a smartwatch.

There is a need for provision of localized metaverse services in a wireless communication network.

### SUMMARY

A virtual experience service may be delivered via a wireless communication network. In addition to the real objects which may host a device for the wireless communication network, their corresponding virtual objects are also capable of interacting with each other and to interact with physical objects via the wireless communication network. There is thus a need to optimize the implementation of virtual experience services in a wireless communication network. Specifically, there is a requirement for a mechanism to support the discovery of devices in a virtual experience service as delivered by a wireless communication network.

Disclosed herein are procedures for discovery of devices in a virtual experience service in a wireless communications network. Said procedures may be implemented by a configuration entity in a wireless communication network and a method in a configuration entity.

There is provided a configuration entity in a wireless communication network, the configuration entity comprising a receiver, a processor and a transmitter. The receiver is arranged to receive a service requirement for communication of virtual devices within a virtual experience service at the wireless communication network, wherein each virtual device corresponds to a physical device identified by a subscriber identity. The processor is arranged to discover a plurality of candidate digital and physical devices for a given area and based on the received service requirement. The processor is further arranged to derive one or more session requirements from the received service requirement; wherein a session is established between any combination of the plurality of candidate digital and physical devices. The processor is further still arranged to determine a parameter for each session. The transmitter is arranged to transmit the determined parameter to at least one network node.

There is further provided a method in a configuration entity, the configuration entity in a wireless communication network. The method comprises receiving a service requirement for communication of virtual devices within a virtual experience service at the wireless communication network, wherein each virtual device corresponds to a physical device identified by a subscriber identity. The method further comprises discovering a plurality of candidate digital and physical devices for a given area and based on the received service requirement. The method further comprises deriving one or more session requirements from the received service requirement; wherein a session is established between any combination of the plurality of candidate digital and physical devices. The method further comprises determining a parameter for each session. The method further comprises transmitting the determined parameter to at least one network node.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for discovery of devices in a virtual experience service in a wireless communications network will now be described, by way of example only, with reference to the accompanying drawings, in which:

FIG. 1 depicts an embodiment of a wireless communication system for discovery of devices in a virtual experience service in a wireless communication network;

FIG. 2 depicts a user equipment apparatus that may be used for implementing the methods described herein;

FIG. 3 depicts further details of the network node that may be used for implementing the methods described herein;

FIG. 4 illustrates a multi-modal feedback service implemented in a wireless communication network;

FIG. 5 illustrates a 5G-enabled Traffic Flow Simulation with Situational Awareness;

FIG. 6 illustrates a method in a configuration entity, the configuration entity in a wireless communication network;

FIG. 7 illustrates a system as an example implementing of the methods described herein;

FIG. 8 illustrates a method for the support, the discovery, and the translation of meta service requirements; and

FIG. 9 illustrates a method for the configuration of network policies for discovered sessions.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

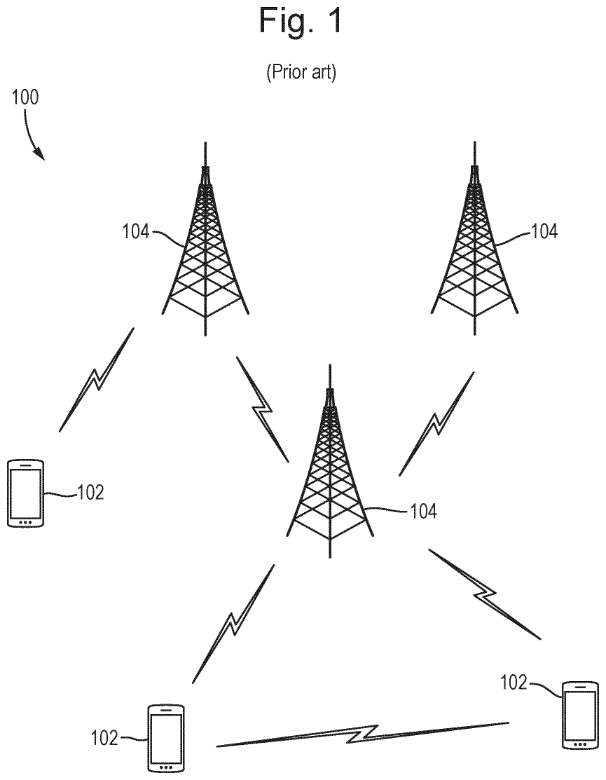

FIG. 1 depicts an embodiment of a wireless communication system 100 for discovery of devices in a virtual experience service in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200, a remote unit 710, or a meta application enabler client 814, 914 as described herein. The network unit 104 may comprise a network function configured to support a virtual experience service, a network node 300, a configuration entity, a meta-aware network function 752, a meta-aware application function 754, or a meta enabler 852, 952 as described herein. In a further implementation, the network node 300 may be deployed as an application function specific to a virtual experience service (which may include XR, AR, VR and/or MR). Further, the network node 300 may comprise an application server which resides at an edge server, a cloud server, or a server in the wireless communication system. The network node 300 may be a meta-aware application function (AF), a media streaming application function, or a media streaming application server which provides support for mobile metaverse services. Such a network node may be implemented consistent with 3GPP SA4.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WIMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

The wireless communication system can be adapted to more efficiently suit use cases and potential requirements for localized virtual experience services. In the context of localized virtual experience service as defined herein, ‘localized’ may refer to a cell area, a tracking area, an edge service area, a private network area (e.g. factory), or a local geographical area (e.g. stadium). Some examples of such use cases are discussed below.

Since the industrial age, engineering design has become an extremely demanding activity. Collaborative and concurrent engineering occur as a concept and methodology at the end of the last century and was defined as a systematic approach to integrated and co-design of products and their related processes. The diversity and complexity of actual products, requires collaboration of engineers from different geographic locations to share the ideas and solutions with customer and to evaluate products development. VR and AR technologies have found their ways into critical applications in industrial sectors such as aerospace engineering, automotive engineering, medical engineering, and in the fields of education and entertainment. The range of technologies include Cave Automatic Virtual Environment (better known by the recursive acronym CAVE) environments, reality theatres, power walls, holographic workbenches, individual immersive systems, head mounted displays, tactile sensing interfaces, haptic feedback devices, multi-sensational devices, speech interfaces, and mixed reality systems.

Mobile virtual experience service based multi-modal feedback service describes a case of multi-physical entities or their digital avatars interacting with each other. New feedback modalities are also introduced in this use case to satisfy new scenarios and requirements in the mobile metaverse. For example, the mobile metaverse is a cyberspace parallel to the real world, which tends to make the virtual world more realistic and make the real world richer. Such a service tends to better utilize different feedback cues and achieve multi-modal feedback cues to adapt to different scenarios, satisfying the accuracy of the task and user experience, and so on. More modalities should be explored to meet more immersion requirements of the physical entities in the real world such as smell and taste. To realize a more immersive requirement of different scenarios in the mobile metaverse, it is important to explore these temporal in-sync or out-of-sync boundaries for audio, video, haptic, scent, taste, and so on.

Physical devices, physical entities and physical objects exist in physical space, which may be referred to as the real-world. This is in contrast to virtual devices, virtual entities and virtual objects which exist in the virtual space of a virtual experience service. There may be a mapping between physical devices, physical entities and physical objects and to virtual devices, virtual entities and virtual objects. The mapping may be one-to-one, many-to-one, or one-to-many. Physical space can be defined as the physical world or real environment comprising, among others, the physical objects and/or devices running the software that delivers the virtual experience service. Hardware that delivers the virtual experience service may be distributed geographically and distributed over different software environments. The hardware may be located physically close to where the physical users of the virtual experience service are physically located.

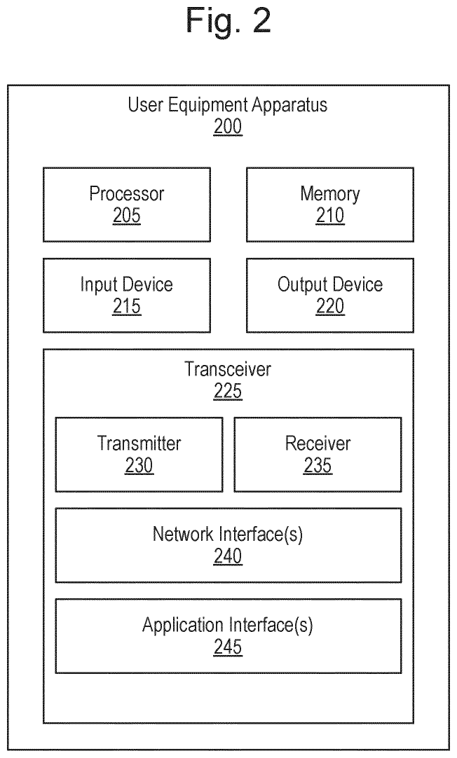

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a remote unit 710, or a meta application enabler client 814, 914 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

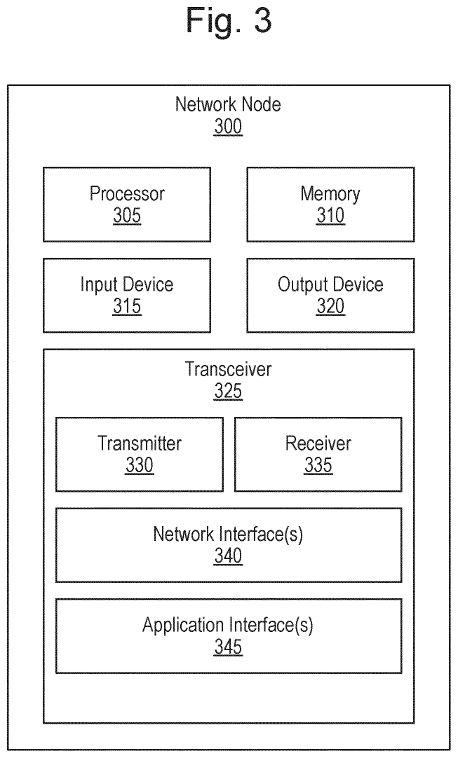

FIG. 3 depicts further details of the network node 300 that may be used for implementing the methods described herein. The network node 300 may comprise, for example, a network function configured to support a virtual experience service, a network unit 104, a configuration entity, a meta-aware network function 752, a meta-aware application function 754, or a meta enabler 852, 952 as described herein. In a further implementation, the network node 300 may be deployed as an application function specific to a virtual experience service (which may include XR, AR, VR and/or MR). Further, the network node 300 may comprise an application server which resides at an edge server, a cloud server, or a server in the wireless communication system. The network node 300 may be a meta-aware application function (AF), a media streaming application function, or a media streaming application server which provides support for mobile metaverse services. Such a network node may be implemented consistent with 3GPP SA4.

The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

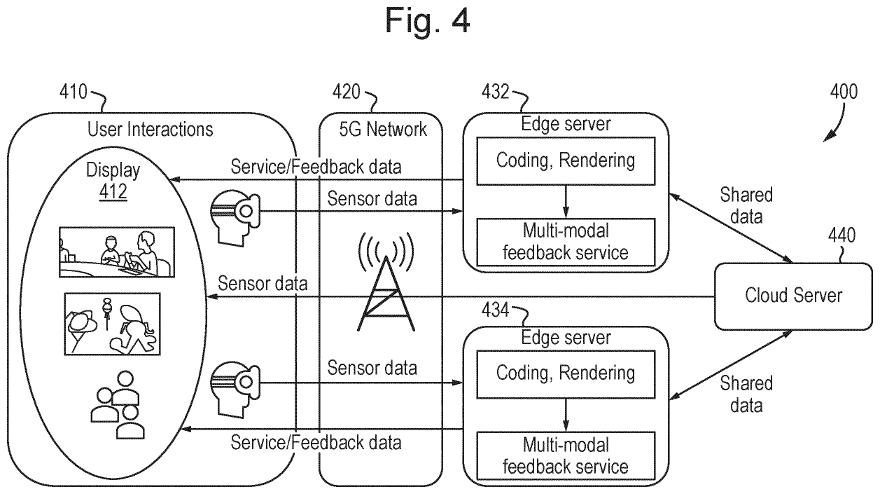

FIG. 4 illustrates a multi-modal feedback service implemented in a wireless communication network. User interactions 410 with a user equipment having a display 412 are captured as sensor data which is sent via a 5G network 420 to one or more edge servers 432, 434. The user equipment is arranged to run an application for allowing a user to interact with the metaverse. Each Edge server 432, 434 may provide coding and rendering services and multi-modal feedback service. The edge server 432, 434 sends service data and/or feedback data back to the user equipment. The edge server 432, 434 sends shared data to a cloud server 440. A mobile metaverse based multi-modal feedback service may be deployed at the edge/cloud server 432, 434 440 for different scenarios. During the application running period, the physical entities of the wireless communication network may deliver an immersive experience to the users via their avatars, and the multi-modal feedback data may be exchanged with each other, whether the physical entities are in proximity or non-proximity. FIG. 4 illustrates how the multi-modal feedback service is applied in the mobile metaverse, and the major impact on 3GPP is whether and how 5GS can be used to better utilize different feedback cues and achieve multi-modal feedback cues concerning the experiences of the multi-physical entities.

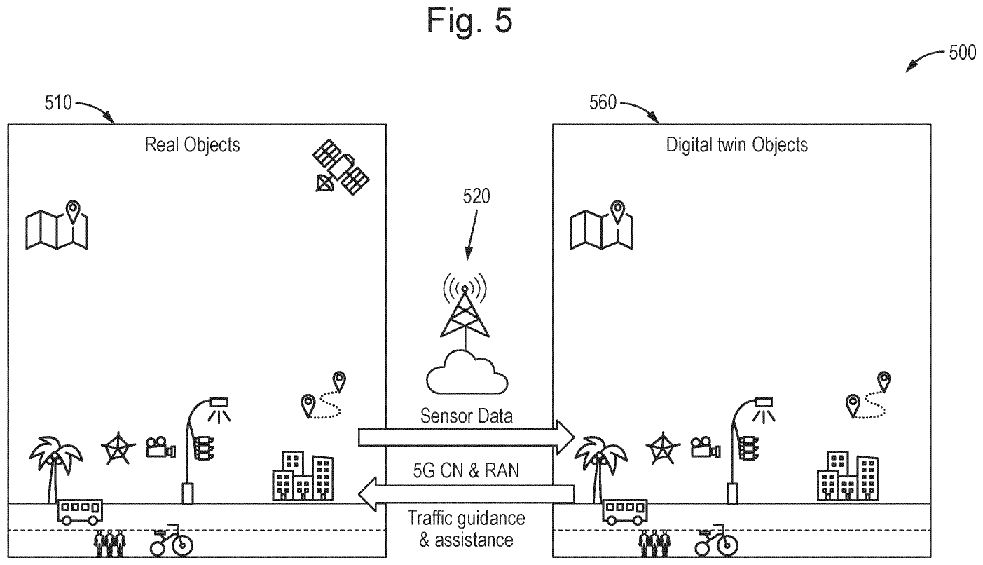

FIG. 5 illustrates a 5G-enabled Traffic Flow Simulation with Situational Awareness. With the support of 5GS, real-time information and data about the real objects can be delivered to virtual objects in the metaverse. FIG. 5 shows a plurality of real objects 510, and a virtual world comprising a plurality of digital twin objects 560. A wireless communication network 520 carries sensor data from the real objects 510 and delivers this to the digital twin objects 560. The wireless communication network 520 delivers situational information from the digital twin objects 560 in the virtual space back to the real objects 510. Such situational information may comprise traffic guidance and assistance data. In this way, the road infrastructure and traffic participants including vulnerable road users can form a smart transport metaverse. Then real-time processing and computing can be conducted to support traffic simulation and also situational awareness and real time path guidance and real-time safety, or security alerts can be generated for ICVs as well as the driver and passengers.

To support traffic flow simulation and situational awareness service, the 5G network 520 needs to provide low latency, high data rate and high reliability transmission, and in addition, the 5G network 520 may also need to be further enhanced to meet the service requirements for 5G-enabled traffic flow simulation and situation awareness. Meanwhile, in addition to the real objects 510 which may host the UE for cellular system, their corresponding virtual objects 560 are also capable of interacting with each other and interact with physical objects 510 via 5GS.

For all scenarios, there is a need to define how the digital devices are instantiated and onboarded to wireless communication network platforms (that support mobile virtual experience services) and how a digital device discovers other digital devices within the mobile virtual experience service.

Accordingly, there is a need to support the discovery and grouping of digital devices to interact via the mobile network. There is also a need to configure the quality of service (QOS) for sessions within the virtual experience service. The present document presents solutions to these problems.

There is provided a configuration entity in a wireless communication network, the configuration entity comprising a receiver, a processor and a transmitter. The receiver is arranged to receive a service requirement for communication of virtual devices within a virtual experience service at the wireless communication network, wherein each virtual device corresponds to a physical device identified by a subscriber identity. The processor is arranged to discover a plurality of candidate digital and physical devices for a given area and based on the received service requirement. The processor is further arranged to derive one or more session requirements from the received service requirement; wherein a session is established between any combination of the plurality of candidate digital and physical devices. The processor is further still arranged to determine a parameter for each session. The transmitter is arranged to transmit the determined parameter to at least one network node.

Accordingly, there is provided a mechanism to support the discovery & translation of service requirements for a virtual experience service as delivered by a wireless communication network. There is further provided a mechanism for the configuration of network policies for discovered sessions. Such mechanisms facilitate delivery of a virtual experience service over a wireless communication network while ensuring sufficient performance and providing optimized use of wireless communication network resources.

The service requirement can be a performance requirement, an availability requirement, a KPI, an application QoS requirement, a user QoE requirement, a virtual experience service QoE requirement, or a combination thereof.

The discovery of the plurality of candidate digital and physical devices for a given area can be based on the device capabilities and mobile metaverse application support, as well as other factors like the battery level of the devices, network conditions, network status (i.e. connected or not), dependencies to other devices, absolute or relative location of the device in physical or virtual space, mobility pattern (static vs dynamic), the reliability of the device, the trust of the device, the type of the device or a combination thereof. The discovery may happen with the support of a Common API Framework (CAPIF). CAPIF is specified in 3GPP TS 23.222 v17.6.0. In particular, a CAPIF Core Function (CCF) may be leveraged by the edge/cloud data network deploying the meta server/enabler server.

A session requirement may correspond to a network or application session between two or more devices and/or between a device and a server or network entity. Such a session requirement may include one or more of a performance, availability, load, QoE, QOS requirement for the respective session.

The subscriber identity may relate to a wireless communication network subscription. The virtual devices are arranged to interact within a digital reality. The digital reality may be the Metaverse. The virtual experience service may comprise the metaverse. The service requirement may comprise a metaverse related service requirement. The given area may be defined as either a physical area or a digital area.

The parameter may comprise a network policy. The network node may comprise an application function. The network node may comprise an OAM, a NF, or a UE. The processor may be arranged to discover a plurality of candidate digital and physical devices for a given area and based on the received service requirement using physical distance between devices, and/or virtual distance between avatars associated with the devices. The physical devices may comprise a user equipment (UE) as defined by 3GPP.

The parameter may comprise at least one of: a network configuration or a PDU set marking, a slice selection, a Radio Access Technology (RAT) selection, and/or an interface selection.

The session can be an application layer session and/or a PDU session.

The service requirement may comprise a smart contract for transactions between virtual devices within the virtual experience service. The smart contract may be made between a meta user and a meta service provider. Smart contracts in the Metaverse exist to automate operations and ensure that actions such as trading, and transactions are done according to the predetermined rules. Smart contracts are digital contracts that are programmed and run on the blockchain.

The processor may be arranged to discover a plurality of candidate digital and physical devices for a given area and based on the received service requirement by querying the wireless communication network.

The session may be established between any pair of the plurality of candidate digital and physical devices and that use the wireless communication network for communication.

The plurality of candidate digital and physical devices may support a localized virtual experience service. The localized virtual experience service may comprise a localized metaverse service.

The configuration entity may further comprise using a simulation engine to provide simulations based on virtual objects within the virtual experience service. The virtual objects may comprise digital twins of virtual devices or of physical objects. Such simulations may support identifying network parameters and/or policies for the virtual experience service.

The operation of the simulation engine may be based on a request from a server in the virtual experience service or subscription and comprises different hypotheses on network parameters and/or policies.

The processor may be further arranged to determine a PDU-set delay budget and a PDU-set error rate, and the transmitter may be arranged to send the PDU-set delay budget and the PDU-set error rate to the wireless communication network.

The transmitter is arranged to send the PDU-set delay budget and the PDU-set error rate to the wireless communication network as part of a Quality of Service procedure.

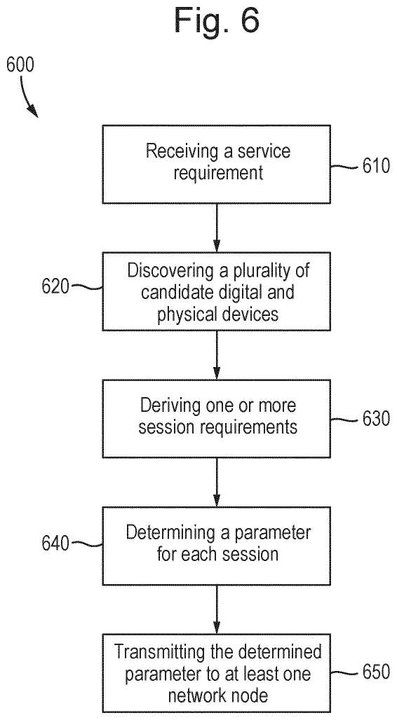

FIG. 6 illustrates a method 600 in a configuration entity, the configuration entity in a wireless communication network. The method 600 comprises receiving 610 a service requirement for communication of virtual devices within a virtual experience service at the wireless communication network, wherein each virtual device corresponds to a physical device identified by a subscriber identity. The method 600 further comprises discovering 620 a plurality of candidate digital and physical devices for a given area and based on the received service requirement. The method 600 further comprises deriving 630 one or more session requirements from the received service requirement; wherein a session is established between any combination of the plurality of candidate digital and physical devices. The method 600 further comprises determining 640 a parameter for each session. The method 600 further comprises transmitting 650 the determined parameter to at least one network node.

Accordingly, there is provided a mechanism to support the discovery & translation of service requirements for a virtual experience service as delivered by a wireless communication network. There is further provided a mechanism for the configuration of network policies for discovered sessions. Such mechanisms facilitate delivery of a virtual experience service over a wireless communication network while ensuring sufficient performance and providing optimized use of wireless communication network resources.

The subscriber identity may relate to a wireless communication network subscription. The virtual devices are arranged to interact within a digital reality. The digital reality may be the Metaverse. The virtual experience service may comprise the metaverse. The service requirement may comprise a metaverse related service requirement. The given area may be defined as either a physical area or a digital area.

The parameter may comprise a network policy. The network node may comprise an application function. The network node may comprise an OAM, a NF, or a UE. The processor may be arranged to discover a plurality of candidate digital and physical devices for a given area and based on the received service requirement using physical distance between devices, and/or virtual distance between avatars associated with the devices. The physical devices may comprise a user equipment (UE) as defined by 3GPP.

The parameter may comprise at least one of: a network configuration or a PDU set marking, a slice selection, a RAT selection, and/or an interface selection. The session can be an application layer session and/or a PDU session.

The service requirement may comprise a smart contract for transactions between virtual devices within the virtual experience service. The smart contract may be made between a meta user and a meta service provider. Smart contracts in the Metaverse exist to automate operations and ensure that actions such as trading, and transactions are done according to the predetermined rules. Smart contracts are digital contracts that are programmed and run on the blockchain.

Discovering a plurality of candidate digital and physical devices for a given area may be based on the received service requirement by querying the wireless communication network.

A session may be established between any pair of the plurality of candidate digital and physical devices and that use the wireless communication network for communication.

The plurality of candidate digital and physical devices may support a localized virtual experience service. The localized virtual experience service may comprise a localized metaverse service.

The method may further comprise using a simulation engine to provide simulations based on virtual objects within the virtual experience service. The virtual objects may comprise digital twins of virtual devices or of physical objects. Such simulations may support identifying network parameters and/or policies for the virtual experience service.

The operation of the simulation engine may be based on a request from a server in the virtual experience service or subscription and comprises different hypotheses on network parameters and/or policies.

The method may further comprise determining a PDU-set delay budget and a PDU-set error rate, and sending the PDU-set delay budget and the PDU-set error rate to the wireless communication network.

The PDU-set delay budget and the PDU-set error rate may be sent to the wireless communication network as part of a Quality of Service procedure.

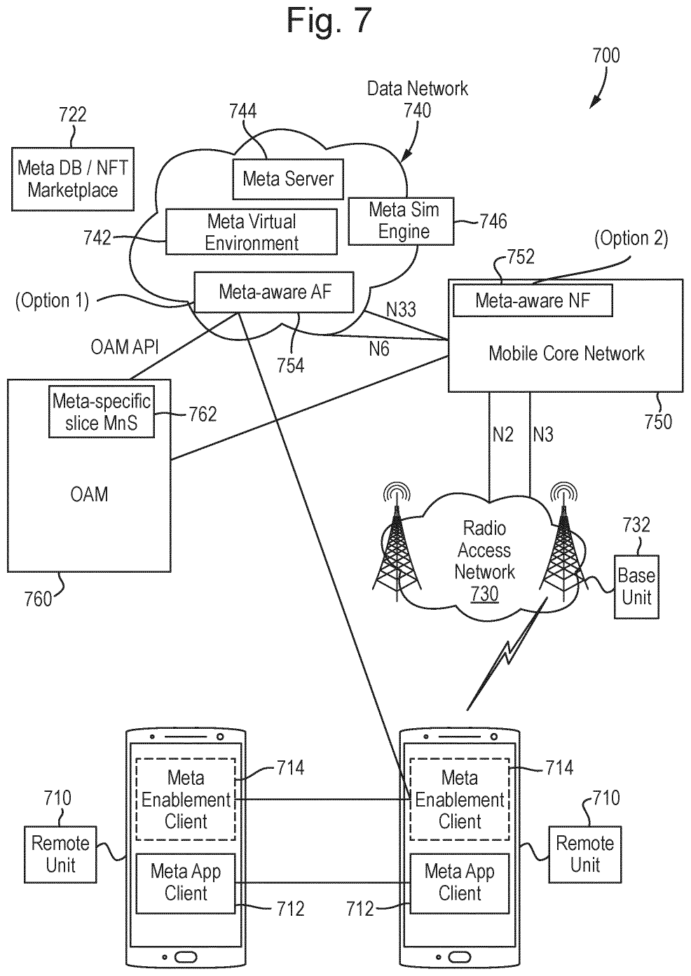

FIG. 7 illustrates a system 700 as an example implementation of the methods described herein. The system 700 comprises a plurality of remote units 710, a radio access network 730 comprising at least one base unit 732, a mobile core network 750, a meta aware network function 752, a meta-aware application function 754, an Operations, Administration and Maintenance (OAM) 760, and a data network 740 that comprises a meta server 744. The remote unit 710 may comprise a remote unit 102, a user equipment apparatus 200, or a meta application enabler client 814, 914 as described herein. The meta-aware network function 752 or the meta-aware application function 754 may comprise a network unit 104, a network node 300, a configuration entity, or a meta enabler 852, 952 as described herein.

A meta database 722 may store data related to the operation of the mobile metaverse service. Such data may comprise Meta profiles and includes an objects database. The meta database 722 may include a Marketplace. Interaction with the meta database 722 can be via a blockchain or some distributed ledger network. A Meta profile can be in certain implementations one or more NFTs (hence the meta database 722 may operate as an NFT marketplace and storage).

The meta database 722 may store Meta profiles and objects or NFTs owned by end users. Such profiles and objects are uploaded at the meta database 722 from the meta user (which can be the platform where the NFT transactions happen or a data storage entity at the service provider domain).

The meta database 722 may store Meta profiles/objects or NFTs owned by Meta service provider such profiles/objects are pre-configured at the meta database 722 by the meta-service provider. Such objects can be environment objects to be used at the meta world, e.g. a table, a bot or some parameters which can change real time (e.g. the weather changes to be shown at the virtual world)

The meta database 722 may store NFTs owned by mobile network operator (MNO) this is the case when the communication and computational resources are digitized and provided as a means of interaction between virtual objects. For example, a communication link between two avatars or a network slice to be used for communication between physical and virtual devices can be provided as an NFT by the MNO. So, the service provider may buy this service for the meta world service, by interacting with the NFT marketplace/meta database 722. This allows the meta service provider to automatically reserve dedicated slice/resources for the communication using the blockchain network (no mediator).

The data network 740 includes a Meta Virtual Environment 742, which is a virtual environment that can be also within the meta server 744, and includes the metaverse world created, without the avatars/networked virtual devices or dynamic objects. In such environment, the visualization of objects can be possible. Further, rendering may be provided based on object IDs to recreate avatars and links between avatars.

The meta Server 744 is the processing entity where the metaverse service runs. Such a server can be an edge deployed/native server or a centralized/cloud server or a federated server (across multiple edge/clouds). The meta server 744 is deployed by the meta-service provider and is hosted at a edge/cloud of the wireless communication network. Such a server 744 can provide gaming meta services, social network services, vertical services etc.

Each remote unit 710 comprises a meta application client 712 and a meta enablement client 714. The meta-application client 712 is the application at the UE side (e.g. VR headset) which runs the mobile metaverse service. The meta enablement client 714 is the application enabler at the UE side which provides support or “awareness” to the meta-applications. Possible capabilities of the meta enablement client 714 include the translation of quality of experience (QoE) parameter to requested network quality of service (QOS) parameter, and/or traffic steering, monitoring network conditions, and supporting the collection of sensor data and delivery of them. Traffic steering may be implemented by way of a UE route selection policy rules. A QOS parameter may be a metric such as jitter, delay/latency, packet error rate, channel loss, data rate/throughput, connection density, communication service availability probability, relative delay/latency among two or more digital and/or physical devices, update rate, and/or encoding rate for media traffic. A QoE parameter may comprise a metric such as user satisfaction, metrics related to Average Throughput, Buffer Level, Play List, Presentation Delay, Field of View, Resolution, Refresh Rate, MOS (“Mean Opinion Score”), frequency and/or duration of stalling events, occurrence of transport discontinuities (including duration thereof), and/or High-resolution Real-time Video Quality. The QoS and QoE targets may be based on those defined for VR in 3GPP TR 26.929 v17.0.0.

The data network 740 further comprises a Meta Simulation Engine 746. The meta simulation engine 746 is a platform that creates data samples based on digital twins and provides performance measurements under different what-if-scenarios. The Meta Server 744 can consume these outputs to improve user experience, or pro-actively adapt behavior or trigger network requirement changes. The meta Simulation engine 746 consists of tools and configurations to perform simulations based on digital twins and on real data.

The OAM 760 comprises a Meta-specific slice Management Service (MnS) 762. The meta-specific MnS 762 may comprise a management function (MF) which handles the network/slice configuration and adaptation to address meta-SP requirements. Such service can be automated and dynamically interact with the meta aware network function 752.

The system 700 may comprise either a meta aware network function 752 or a meta-aware application function 754, or both. The meta-aware network function 752 or the meta-aware application function 754 may be implemented by way of an enabler server. The meta-aware application function 754 is located at the data network 740 (option 1 illustrated in FIG. 7). Alternatively, the meta-aware network function 752 is located at the mobile core network 750 (option 2 illustrated in FIG. 7). The meta aware network function 752 and/or meta-aware application function 754 support the discovery and requirements translation between the Meta Server 744 and the underlying network(s). The meta aware network function 752 and/or meta-aware application function 754 can perform one or more of the following functions:
support the discovery of meta users and session info for a meta service and group them;
translate meta service requirements (for blockchain enabled digital objects such requirements are derived based on smart contracts) to network policies or management triggers; and
influence the parameters for the packet data unit (PDU) sets according to the service, for the packets of each discovered session and provides to the network (to allow the 5GC to identify PDU sets information).

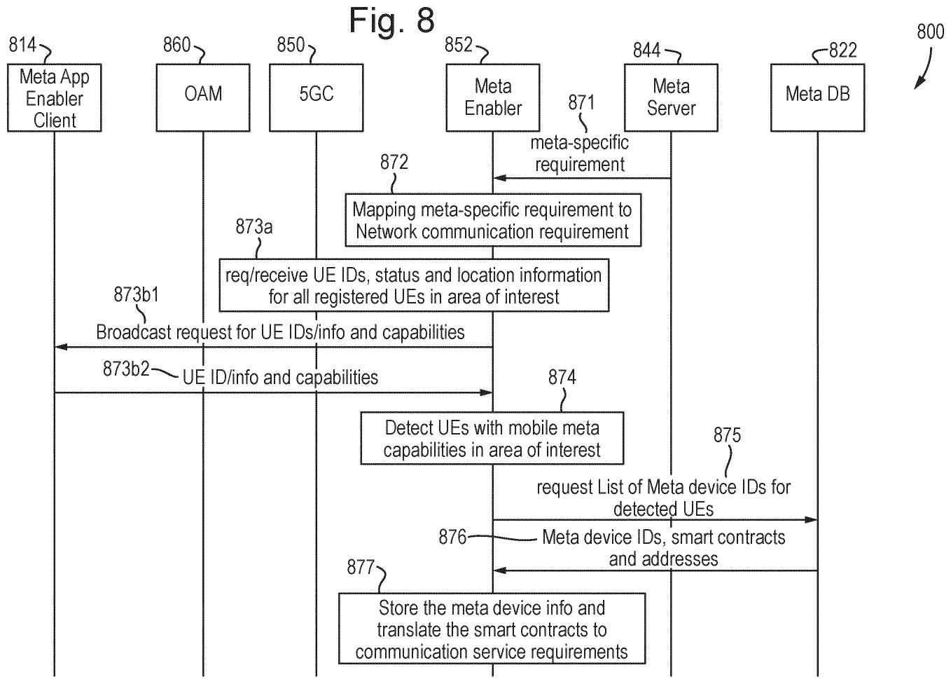

FIG. 8 illustrates a method 800 for the support, the discovery, and the translation of meta service requirements. FIG. 8 illustrates a system comprising a meta application enabler client 814, which is implemented at a UE, an OAM 860, a 5G core 850, a meta enabler 852, a meta server 844 and a meta database 822. The meta enabler 852 may comprise a meta NF, a meta AF or a meta middleware function. The meta enabler 852 may comprise a network unit 104, a network node 300, a configuration entity, a meta-aware network function 752, a meta-aware application function 754, or a meta enabler 952 as described herein. The meta enabler 852 may comprise any virtual space enabler and is not necessarily restricted to an enable of the metaverse. The meta enabler 1052 may comprise an enablement service at an application layer which is tailored for virtual experience services delivered via a wireless communication network, such as the mobile meta verse. The meta application enabler client 814 may be implemented by a remote unit 102, a user equipment apparatus 200, a remote unit 710, or a meta application enabler client 914 as described herein.

The illustrated process begins at 871, with the meta enabler 852 receiving an application requirement from the meta server 844. The application requirement may be generated by a meta service provider (or from a meta user). The application requirement is for configuring the communication service and/or network requirements for a mobile metaverse service. This application requirement comprises a set of application performance metrics (QoE, QoS) and availability targets for the mobile metaverse service. A mobile metaverse service is defined as the communication between a physical device and a digital device (or groups of devices) in the virtual space of the metaverse world via the wireless communication network. For example, video/audio/sensor communication between VR glasses and the metaverse application. Further, the mobile metaverse service may comprise the communication between two or more digital devices in the metaverse world. For example, video/audio communication between digital avatars in the metaverse world. The video/audio communication is also communicated to the physical device via the mobile communication network. The application requirement can include a metaverse service coverage area, time of validity, and a preferred network slice ID.

At 872, the meta enabler 852 translates the application requirement to a network communication requirement for the mobile metaverse service. Such a network communication requirement may include the communication means, the RAT/spectrum considerations, the traffic patterns (which can be the application traffic schedules and/or the PDU set information for the application sessions), the network topological area for which the service applies. The network communication requirement may comprise service profile and an area of interest. The area of interest may be defined as a list of cells.

At 873, based on the network communication requirements, the meta enabler 852 obtains information from the 5G core (identities/addresses, meta capabilities and location info) for all the registered/connected UEs within the network coverage area where the metaverse service plans to be deployed. Such retrieval can be based on SEAL LMS service for receiving the list of Ues and their locations in a given area/zone (873a), or by querying this information from the Ues directly (via the enablement layer) via broadcast transmissions for the area of interest (as illustrated by 873b1/873b2). For example, at 873b1 a request for UE IDs/info and capabilities (e.g. meta support) is broadcast to all Ues in target area. In reply, at 873b2, UE ID/info and capabilities are sent from the meta app enabler client 814 in each UE. The UE ID/info and capabilities may comprise meta support flag, profile, energy data, type of UE e.g. VR headset.

At 874, upon obtaining the information on UEs and their status in a given area, the meta enabler 852 detects the UEs which are meta-capable and are connected to network. It should be noted that step 874 may precede 873 i.e. the UE interfaces with application and notifies AF of the IP address.

At 875, based on the detected UEs with meta capabilities, the meta enabler 852 requests from the Meta DB 822 information on the digital representations of the UEs within this area and identifying which of them have avatars which interact to each other. The Meta device IDs may be based on UE ID/public address for detected UEs.

For the rest UEs which do not have avatars, the middleware will either create digital twins (operated by the MNO/middleware provider) to introduce at the metaverse or will not take them into account.

The discovery of the avatar UEs may be based on the reception of a digital UE ID or NFT ID and can be a group of digital devices which are owned by the user (e.g. smartphone, watch, gadgets). The discovery can be performed via a blockchain network or can be acquired by the meta database 822 off-chain (e.g. if the meta database 822 is deployed at the data network and the digital copies/avatars info are already available from the time the UE registers to the network/middleware).

At 876, the meta enabler 852 receives the digital device IDs and information for the digital devices/objects within the area (if the digital objects are blockchain-enabled entities). A physical UE may be mapped to more than one digital object (e.g. a user has multiple digital assets like the avatar, cloths and other possessions) or the opposite (an avatar corresponds to one or more physical devices); hence the mapping can be N to M (albeit only for the digital objects which are transactionable).

The information for the digital devices may optionally comprise a smart contract. Such an optional smart contract may be employed when a blockchain is used. Such a smart contract may comprise automated scripts which act as rules for the transactions between blockchain-enabled entities (like the avatars in meta-world). These smart contracts can influence the translation to network parameters since a trigger event will need to be translated to an automated trigger action towards the network. By way of further example, it should be noted that smart contracts may be employed by the meta server 844 to impose some automated pairs of policies and actions to be applied by the network.

At 877, the meta enabler 852 stores the received digital device info, detect digital UEs with possible interactions (based on the vicinity in meta-world). Where an optional smart contract is used, the meta enabler 852 translates the smart contracts per digital device to application service requirements for the communication among digital UEs.

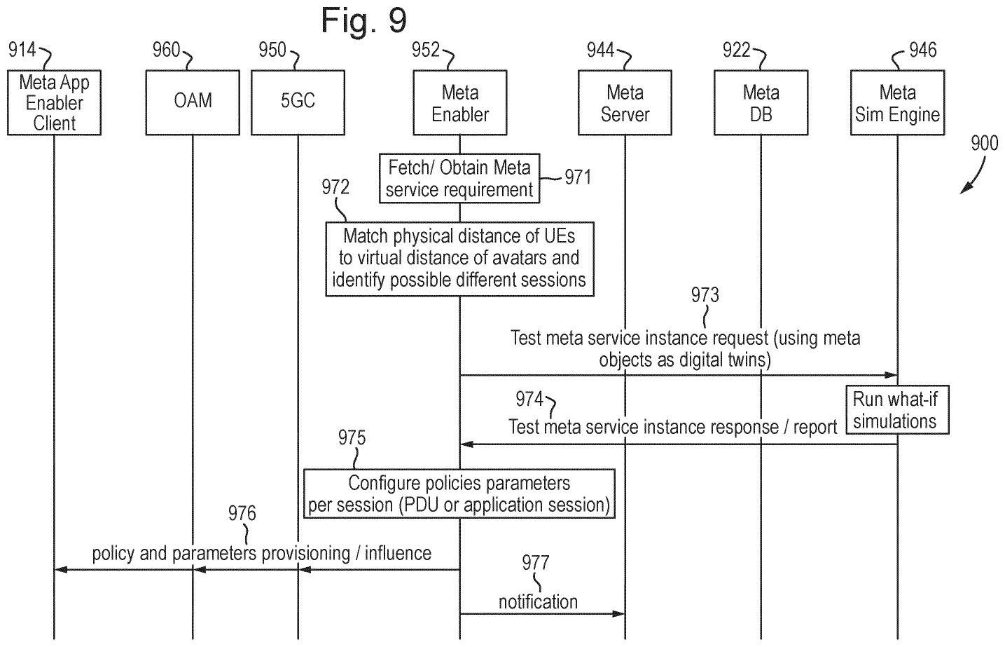

FIG. 9 illustrates a method 900 for the configuration of network policies for discovered sessions. FIG. 9 illustrates a system comprising a meta application enabler client 914, which is implemented at a UE, an OAM 960, a 5G core 950, a meta enabler 952, a meta server 944, a meta database 922 and a meta simulation engine 946. The meta enabler 952 is a discovery and translation entity and may comprise a meta NF, a meta AF or a meta middleware function. The meta enabler 952 may comprise any virtual space enabler and is not necessarily restricted to an enable of the metaverse. The meta application enabler client 914 may be implemented by a remote unit 102, a user equipment apparatus 200, a remote unit 710, or a meta application enabler client 814 as described herein. The meta enabler 952 may comprise a network unit 104, a network node 300, a configuration entity, a meta-aware network function 752, a meta-aware application function 754, or a meta enabler 852 as described herein.

At 971, the meta enabler 952 obtains application service requirements for mobile meta service for the digital devices. (This is comparable to step 877 of FIG. 8.)

At 972, the meta enabler 952 matches the distance among any two digital UEs (avatars) to the physical communication distance among their physical UEs. This can be done via processing the locations of the physical UEs (obtained in the same way as demonstrated in FIG. 8) and matching them with the digital UE locations at the mobile metaverse world (such information can be provided by the meta server). This helps identifying application requirements translation to network requirements, since relative distance between the avatars and the physical UEs (behind the avatars) will identify the performance requirements for the end to end session.

By way of example, if two UE are close to each other and the Meta-server 944 is deployed at an edge cloud, the network/QoS requirements for the session can be relaxed (since the physical to avatar UE sessions and the physical to physical UE session can be accommodated via local paths. On the contrary, if physical UEs are far away, and the avatars are close in vicinity, and data transfer needs to take into account the underlying network delays due to different UPFs/RAN nodes and interfaces for ensuring an appropriate quality of thee for avatar to avatar dynamic transactions.

Optionally, at 973, the meta enabler 952 may request that the meta simulation engine 946 runs what-if-simulations based on the meta objects and the configurations (of spectrum etc), using also as input the physical and digital UE locations/distances among UEs

Also, optionally and conditional upon 973, at 974 the met simulation engine 946 runs simulations and provides back to the meta enabler 95s the simulation outputs for all hypotheses based on the request at 973. Such simulation outputs may also recommend adapting application behavior. Adapting application behavior may comprise using a different codec, or changing the frequency of haptic sensor reports.

At 975, the meta enabler 952 configures sets of network parameters (links, spectrum, slices, . . . ) and policies for the service area based on the smart contract, and optionally the simulation outputs for all possible sessions that need to be provided by the network (physical to digital UE, digital to digital UE, physical to physical UE).

At 976, the meta enabler 952 sends the network parameters and policies for the metaverse service and the given area to the involved network entities (5GC 950, RAN, OAM 960, UE).

The network parameters may include per session QoS requirements for each metaverse service received/sent at/by the UE, where each metaverse service may be composed of multi-modal type of communication conveying audio, video or haptic/sensor information from/between the UE. The meta enabler 952 may determine based on such requirements specific latency requirements for each of the sessions.

A PDU (Packet Data Unit) Set may be defined which is composed of one or more PDUs carrying the payload of one unit of information generated at the application level (e.g. a frame or video slice for NRM Services), which are of same importance at application layer. The user plane function (UPF) at the 5G core network (CN) marks the important packets including PDU-Set sequence number, size of the PDU set and indication whether all packets of the same PDU-set needs to be successfully delivered within the PDU-Set delay budget. From the metaverse AF perspective, the AF needs to determine the optimal PDU-set delay budget to deliver such packets to the UE. In addition, the metaverse AF can determine the optimal PDU set error rate which defines the upper bound for the rate of PDU set that have been processed by the sender of a link layer protocol (e.g. RLC in RAN of a 3GPP access) but where all of the PDUs in the PDU-Set are not successfully delivered by the corresponding receiver to the upper layer. The PDU-set delay budget and PDU set error rate can be provided by the AF to the 5GCN as part of the AF session with QoS procedure. Such marking can be made for each of the sessions identified.

At 977, the meta enabler 952 notifies the meta server 944 of the network configuration and access parameters. This step may also include possible recommendation of application parameter to change based on the simulation outputs in step 974.

New virtual spaces such as the Mobile Metaverse bring a new dimension to XR/VR services (since meta is about a persistent large-scale virtual interactive experience, where the digital assets are owned or deployed by the end users), and requires enhancements to future networks (5G and beyond) to ensure connectivity/performance and provide support/optimization. A problem to be solved is how to support the discovery and configuration of digital devices (avatars or digital twins of physical users) to interact via the mobile network, Further, a mechanism is required to configure the QoS for the sessions within meta service.

There is provided herein a mechanism at a Meta AF/enabler server to 1) support the discovery of meta users and session info for a meta service, 2) translate meta service requirements (for blockchain enabled digital objects such requirements are derived based on smart contracts) to network policies or management triggers and 3) influence the parameters for the PDU-sets according to the service, for the packets of each discovered session and provides to the network (to allow the 5GC to identify PDU sets information).

The arrangements described herein facilitate the discovery of an avatar of a UE in virtual space, since the dimension of having both interactions between physical and avatar users is captured. Virtual spaces such as the mobile metaverse services will bring new requirements in terms of discovery and policy provisioning, a mechanism for which is presented herein.

There is provided herein a mechanism to support the discovery & translation of meta service requirements for mobile metaverse services. There is further provided a mechanism for the configuration of network policies for discovered sessions.

Accordingly, there is provided a method for discovery and configuration of sessions for mobile metaverse services. The method comprises: a. obtaining a service requirement for communication between virtual devices in the application layer which correspond to physical subscriber identities; b. discovering a plurality of candidate digital and physical UEs for a given digital or physical area, based on the metaverse related service requirement; c. translating the metaverse related service requirement to a set of service requirements for one or more meta sessions, wherein the sessions can be between digital and physical UEs within an area of interest; d. determining a network policy and/or parameter for the one or more sessions; e. transmitting the determined network policy and/or parameter to at least one application or network node (OAM, NF, UE)

The policy and/or parameter may comprise a network configuration or a PDU set marking, a slice selection, a RAT selection, or an interface selection. The service requirement may comprise a smart contract between the meta user and the meta service provider. The discovery may comprise requesting or subscribing.

The meta sessions may comprise any combination of sessions between physical and digital objects which use the mobile network for the communication. The set of physical devices corresponding to the digital devices may support a localized metaverse service.

A simulation engine may be used to provide simulations based on the digital objects to support identifying network parameters and/or policies for the metaverse service. Providing simulation may be based on a meta server request or subscription and comprises different hypotheses on network parameters and/or policies.

While specific examples have been given in the context of the metaverse, the methods and apparatus described herein may be applied to any virtual experience service.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A configuration entity in a wireless communication network, the configuration entity comprising:
at least one memory; and
at least one processor coupled with the at least one memory and configured to cause the configuration entity to:
receive a service requirement for communication of virtual devices within a virtual experience service at the wireless communication network, wherein each virtual device corresponds to a physical device identified by a subscriber identity;
discover a plurality of candidate digital and physical devices for a given area and based on the received service requirement;
derive one or more session requirements from the received service requirement; wherein a session is established between any combination of the plurality of candidate digital and physical devices;
determine a parameter for each session; and
transmit the determined parameter to at least one network node.

2. The configuration entity of claim 1, wherein the parameter comprises at least one of: a network configuration, a PDU set marking, a slice selection, a RAT selection, and/or an interface selection.

3. The configuration entity of claim 1, wherein the service requirement comprises a smart contract for transactions between virtual devices within the virtual experience service.

4. The configuration entity of claim 1, wherein the at least one processor is configured to cause the configuration entity to discover the plurality of candidate digital and physical devices for the given area and based on the received service requirement by querying the wireless communication network.

5. The configuration entity of claim 1, wherein the session is established between any pair of the plurality of candidate digital and physical devices and that use the wireless communication network for communication.

6. The configuration entity of claim 1, wherein the plurality of candidate digital and physical devices support a localized virtual experience service.

7. The configuration entity of claim 1, wherein the at least one processor is configured to cause the configuration entity to use a simulation engine to provide simulations based on virtual objects within the virtual experience service.

8. The configuration entity of claim 7, wherein an operation of the simulation engine is based on a request from a server in the virtual experience service or subscription and comprises different hypotheses on network parameters and/or policies.

9. The configuration entity of claim 1, wherein the at least one processor is configured to cause the configuration entity to determine a PDU-set delay budget and a PDU-set error rate, and send the PDU-set delay budget and the PDU-set error rate to the wireless communication network.

10. A method in a configuration entity, the configuration entity in a wireless communication network, the method comprising:
receiving a service requirement for communication of virtual devices within a virtual experience service at the wireless communication network, wherein each virtual device corresponds to a physical device identified by a subscriber identity;
discovering a plurality of candidate digital and physical devices for a given area and based on the received service requirement;
deriving one or more session requirements from the received service requirement; wherein a session is established between any combination of the plurality of candidate digital and physical devices;
determining a parameter for each session; and
transmitting the determined parameter to at least one network node.

11. The method of claim 10, wherein the parameter comprises at least one of: a network configuration or a PDU set marking, a slice selection, a RAT selection, and/or an interface selection.

12. The method of claim 10, wherein the service requirement comprises a smart contract for transactions between virtual devices within the virtual experience service.

13. The method of claim 10, wherein discovering the plurality of candidate digital and physical devices for the given area is based on the received service requirement by querying the wireless communication network.

14. The method of claim 10, wherein a session is established between any pair of the plurality of candidate digital and physical devices and that use the wireless communication network for communication.

15. The method of claim 10, wherein the plurality of candidate digital and physical devices support a localized virtual experience service.

16. The method of claim 10, further comprising using a simulation engine to provide simulations based on virtual objects within the virtual experience service.

17. The method of claim 16, wherein an operation of the simulation engine is based on a request from a server in the virtual experience service or subscription and comprises different hypotheses on network parameters and/or policies.

18. The method of claim 10, further comprising determining a PDU-set delay budget and a PDU-set error rate, and sending the PDU-set delay budget and the PDU-set error rate to the wireless communication network.
